(19) United States
(12) Patent Application Publication
(10) Pub. No.: US 2020/0236562 A1
(43) Pub. Date: Jul. 23, 2020

(54) NODE PROFILING BASED ON A KEY PERFORMANCE INDICATOR (KPI)

(71) Applicant: HCL TECHNOLOGIES LIMITED, Uttar Pradesh (IN)

(72) Inventor: Rahul SOUNDRARAJAN, Bengaluru (IN)

(21) Appl. No.: 16/251,797

(22) Filed: Jan. 18, 2019

(51) Int. Cl. H04W 24/02; H04W 24/10; H04L 12/24; H04L 12/26; H04W 8/22

(52) U.S. Cl. CPC H04W 24/02; H04W 24/10; H04L 41/142; G06F 17/18; H04L 43/16; H04W 8/22; H04L 41/145

(57) ABSTRACT

Disclosed is a system for profiling one or more nodes based on a Key Performance Indicator (KPI) associated to a node. Initially, a receiving module receives a flag indicating an issue with the KPI of a node present in a network of nodes. An identification module identifies a set of Performance Management (PM) counters influencing the KPI using machine learning based statistical method of correlation. A determination module determines a subset of PM counters, from the set of PM counters, by comparing each PM counter with a corresponding predefined threshold limit. A normalization module normalizes the subset of PM counters by computing a variance of the subset of PM counters. A profile module profiles one or more nodes, present in the network of nodes, by comparing the variance associated to the node with variance corresponding to each of the one or more nodes.

### PRIORITY INFORMATION

This patent application does not claim priority from any application.

### TECHNICAL FIELD

The present subject matter described herein, in general, relates to node profiling and more particularly to profiling one or more nodes based on a Key Performance Indicator (KPI) associated to a node in a communication network.

### BACKGROUND

Due to an exponential increase in mobile telephony, wireless ecosystem is in a constant state of flux. It has been observed that traffic in wireless ecosystem has surpassed conventionally fixed threshold levels. Thus, in order to cope with the traffic, one or more of software patches, hardware swap-outs, new chipsets and others are continuously implemented in the wireless ecosystem. As a result, the wireless ecosystem is under constant surveillance and any degradation in network performance requires real time attention to locate and recover the health of the wireless ecosystem. Further, conventional system and methodologies exclusively depends on Subject Matter Expert (SME) to identify and resolve one or more issues. Thus, the conventional system and methodologies fail to locate and recover the health of the wireless ecosystem in real time.

### SUMMARY

Before the present systems and methods, are described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and methods for profiling one or more nodes based on a Key Performance Indicator (KPI) associated to a node in a communication network and the concepts are further described below in the detailed description. This summary is not intended to identify essential features of the claimed subject matter nor is it intended for use in determining or limiting the scope of the claimed subject matter.

In one implementation, a system for profiling one or more nodes based on a Key Performance Indicator (KPI) associated to a node in a communication network is disclosed. The system may comprise a processor and a memory coupled to the processor. The processor may execute programmed instructions stored in a plurality of modules present in the memory. The plurality of modules may comprise a receiving module, an identification module, a determination module, a normalization module, and a profile module. Initially, the receiving module may receive a flag indicating an issue with a Key Performance Indicator (KPI) of a node present in a network of nodes. The identification module may identify a set of Performance Management (PM) counters influencing the KPI. In one aspect, the set of PM counters may be identified using machine learning based statistical method of correlation. The determination module may determine a subset of PM counters, from the set of PM counters, by comparing each PM counter with a corresponding predefined threshold limit. Subsequently, the normalization module may normalize the subset of PM counters by adjusting the subset of PM counters to a notionally common scale and then computing a variance of the subset of PM counters. The profile module may profile one or more nodes, present in the network of nodes, by comparing the variance associated to the node with variance corresponding to each of the one or more nodes.

In another implementation, a method for profiling one or more nodes based on a Key Performance Indicator (KPI) associated to a node in a communication network is disclosed. In order to profile the one or more nodes, initially, a flag may be received indicating an issue with a Key Performance Indicator (KPI) of a node present in a network of nodes. Upon receiving the flag, a set of Performance Management (PM) counters influencing the KPI may be identified. In one aspect, the set of PM counters may be identified using machine learning based statistical method of correlation. Subsequent to the identification, a subset of PM counters may be determined from the set of PM counters by comparing each PM counter with a corresponding predefined threshold limit. Further, the subset of PM counters may be normalized by adjusting the subset of PM counters to a notionally common scale and then computing a variance of the subset of PM counters. Furthermore, one or more nodes present in the network of nodes may be profiled by comparing the variance associated to the node with variance corresponding to each of the one or more nodes. In another aspect, the aforementioned method for profiling the one or more nodes based on a Key Performance Indicator (KPI) associated to the node in a communication network may be performed by a processor using programmed instructions stored in a memory.

In yet another implementation, non-transitory computer readable medium embodying a program executable in a computing device for profiling one or more nodes based on a Key Performance Indicator (KPI) associated to a node in a communication network is disclosed. The program may comprise a program code for receiving a flag indicating an issue with a Key Performance Indicator (KPI) of a node present in a network of nodes. The program may further comprise a program code for identifying a set of Performance Management (PM) counters influencing the KPI. In one aspect, the set of PM counters is identified using machine learning based statistical method of correlation. The program may further comprise a program code for determining a subset of PM counters, from the set of PM counters, by comparing each PM counter with a corresponding predefined threshold limit. The program may further comprise a program code for normalizing the subset of PM counters by adjusting the subset of PM counters to a notionally common scale and then computing a variance of the subset of PM counters. The program may further comprise a program code for profiling one or more nodes, present in the network of nodes, by comparing the variance associated to the node with variance corresponding to each of the one or more nodes.

### BRIEF DESCRIPTION OF THE DRAWINGS

The foregoing detailed description of embodiments is better understood when read in conjunction with the appended drawings. For the purpose of illustrating the disclosure, example constructions of the disclosure are shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for profiling one or more nodes based on a Key Performance Indicator (KPI) associated to a node in a communication network, in accordance with an embodiment of the present subject matter.

FIG. 2 illustrates the system, in accordance with an embodiment of the present subject matter.

FIGS. 3, 4, 5 and 6 illustrates an example of the system, in accordance with an embodiment of the present subject matter.

FIG. 7 illustrates a method for profiling one or more nodes based on a Key Performance Indicator (KPI) associated to a node in a communication network, in accordance with an embodiment of the present subject matter.

### DETAILED DESCRIPTION

Some embodiments of this disclosure, illustrating all its features, will now be discussed in detail. The words “including,” “comprising,” “consisting,” and “having,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

The present invention facilitates profiling of one or more nodes based on Key Performance Indicators (KPI) in a communication network. It is to be noted that the KPI indicates behavior of each node present in a network of nodes of the communication network. Example of KPIs may include, but not limited to, call drop rate, network failure, equipment failure, response time, waiting time, probability of immediate execution, CPU utilization, and throughput. The KPI may be computed by applying arithmetic logic on a set of Performance Management (PM) counters influencing the KPI. Example of PM counters include, but not limited to, events, success rate, reset events, resource usage, traffic data, and signaling.

In order to profile the one or more nodes, present in a network of nodes, it is important to analyze KPI of each node. It is to be noted that KPI inherits characteristics of the set of PM counters. In one implementation, the KPI may inherit characteristics of a group of PM counters when considered together. Thus, it is observed that two nodes having same KPI may not have the similar group of PM counters influencing the KPI. Hence, in order to compare KPI of two nodes it is imperative to normalize a subset of PM counters associated to each node on a common scale.

During implementation, a flag indicating an issue with a node may be received. Upon receipt of the flag, a KPI related to the issue may be identified. Subsequently, the set of PM counters influencing the KPI may be identified using machine learning based statistical method of correlation. Further, a subset of PM counters may be determined from the set of PM counters by comparing each PM counter with a corresponding predefined threshold limit. Thresholding may be a tunable provided to the network engineer to filter out known or expected variations in data. For example, due to a specific feature or re-dimensioning, certain parameters are expected to change significantly. Depending on the requirement or actual use case, the thresholding step may be exercised or skipped. Furthermore, the subset of PM counters may be normalized to compare the KPI on the common scale. Upon normalizing, the one or more nodes present in the network of nodes may be profiled. Once the one or more nodes are profiled, a patch may be installed to resolve the flag. It is to be noted that outcome of the profiling may reveal other network nodes that may benefit from the patch although the flag indicating the degradation may or may not have yet risen on the set of network nodes. In an implementation, the patch may be a resolution of a software issue or replacement of hardware equipment.

While aspects of described system and method for profiling one or more nodes based on a Key Performance Indicator (KPI) associated to a node in a communication network and may be implemented in any number of different computing systems, environments, and/or configurations, the embodiments are described in the context of the following exemplary system.

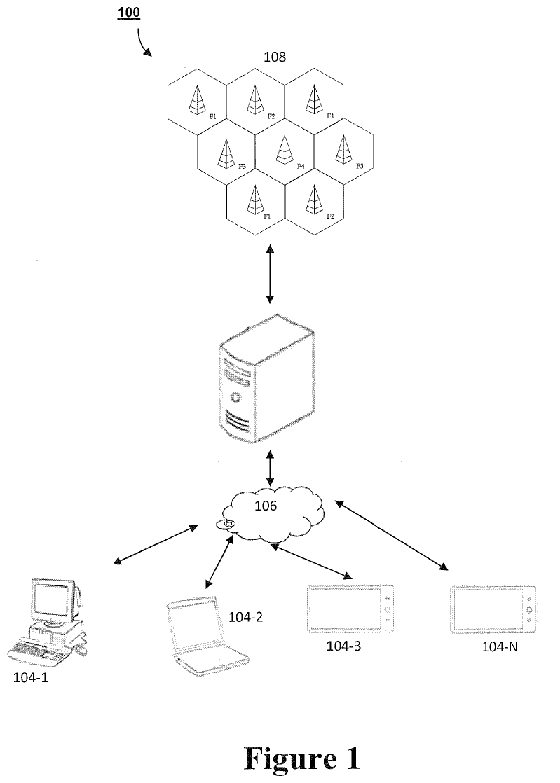

Referring now to FIG. 1, a network implementation 100 of a system 102 for profiling one or more nodes based on a Key Performance Indicator (KPI) associated to a node in a communication network is disclosed. Initially, the system 102 may receive a flag indicating an issue with a Key Performance Indicator (KPI) of a node present in a network of nodes 108. The system 102 may identify a set of Performance Management (PM) counters influencing the KPI. In one aspect, the set of PM counters may be identified using machine learning based statistical method of correlation. The system 102 may determine a subset of PM counters, from the set of PM counters, by comparing each PM counter with a corresponding predefined threshold limit. Subsequently, the system 102 may normalize the subset of PM counters by computing a variance of the subset of PM counters. The system 102 may profile one or more nodes, present in the network of nodes 108, by comparing the variance associated to the node with variance corresponding to each of the one or more nodes.

Although the present disclosure is explained considering that the system 102 is implemented on a server, it may be understood that the system 102 may be implemented in a variety of computing systems, such as a laptop computer, a desktop computer, a notebook, a workstation, a mainframe computer, a server, a network server, a cloud-based computing environment. It will be understood that the system 102 may be accessed by multiple users through one or more user devices 104-1, 104-2 . . . 104-N, collectively referred to as user 104 or stakeholders, hereinafter, or applications residing on the user devices 104. In one implementation, the system 102 may comprise the cloud-based computing environment in which a user may operate individual computing systems configured to execute remotely located applications. Examples of the user devices 104 may include, but are not limited to, a portable computer, a personal digital assistant, a handheld device, and a workstation. The user devices 104 are communicatively coupled to the system 102 through a network 106.

In one implementation, the system 102 may be connected to the network of nodes 108 through the network 106. Each node present in the network of nodes 108 may be connected to every other node through the network 106. It is to be noted that each node represents a base station or network station of a telecommunication network. In another implementation, the telecommunication network may be wireless or wired implemented as one of the different types of networks, such as intranet, local area network (LAN), wide area network (WAN), the internet, and the like.

In another implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

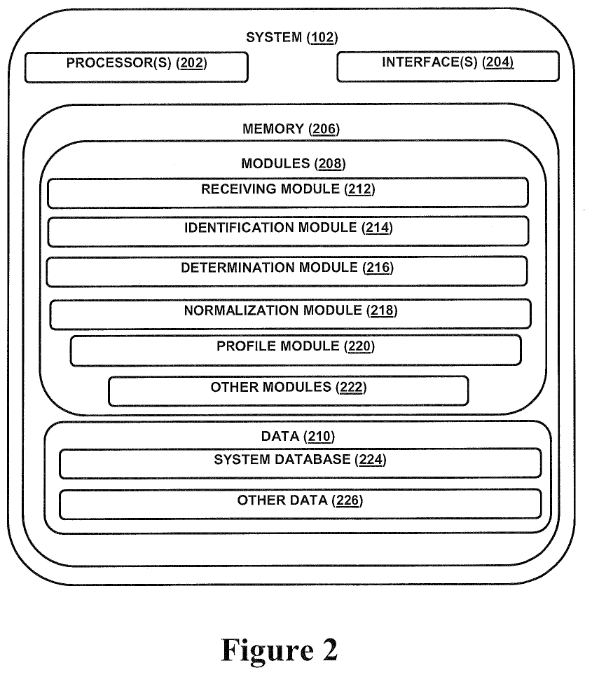

Referring now to FIG. 2, the system 102 is illustrated in accordance with an embodiment of the present subject matter. In one embodiment, the system 102 may include at least one processor 202, an input/output (I/O) interface 204, and a memory 206. At least one processor 202 may be implemented as one or more microprocessors, microcomputers, microcontrollers, digital signal processors, central processing units, state machines, logic circuitries, and/or any devices that manipulate signals based on operational instructions. Among other capabilities, at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a receiving module 212, an identification module 214, a determination module 216, a normalization module 218, and a profile module 220 and other modules 222. The other modules 222 may include programs or coded instructions that supplement applications and functions of the system 102. The modules 208 described herein may be implemented as software modules that may be executed in the cloud-based computing environment of the system 102.

The data 210, amongst other things, serves as a repository for storing data processed, received, and generated by one or more of the modules 208. The data 210 may also include a system database 224 and other data 226. The other data 226 may include data generated as a result of the execution of one or more modules in the other modules 222.

As there are various challenges observed in the existing art, the challenges necessitate the need to build the system 102 for profiling one or more nodes based on a Key Performance Indicator (KPI) associated to a node in a communication network, at first, a user may use the client device 104 to access the system 102 via the I/O interface 204. The user may register them using the I/O interface 204 in order to use the system 102. In one aspect, the user may access the I/O interface 204 of the system 102. The system 102 may employ the receiving module 212, the identification module 214, the determination module 216, the normalization module 218, and the profile module 220. The detail functioning of the modules is described below with the help of figures.

The present system 102 facilitates profiling of one or more nodes based on a Key Performance Indicator (KPI) associated to a node in a communication network. To do so, initially, the receiving module 212 receives a flag from at least one of a consumer, a network operator, a third party service provider, a technician, and a subject matter expert. The flag may indicate an issue in a particular area covered by the node. Example of the issue may include, but not limited to, call drop rate, network connectivity, cross connections, and portability problems. It is to be noted that each node in the communication network may be profiled based on KPI associated to the node. The KPI indicates behavior of the devices operating in the node. Examples of the devices include mobile handsets, landline, laptop, computer, gaming consoles, and other. In one implementation, the flag may indicate an issue with the KPI of the node present in a network of nodes.

Once the flag is received, the identification module 214 identifies a set of Performance Management (PM) counters influencing the KPI. Examples of the KPI comprises at least one of call drop rate, network failure, equipment failure, response time, waiting time, probability of immediate execution, CPU utilization, and throughput. It must be noted that not each PM counter influences the KPI. Thus, it is imperative to identify the set of PM counters impacting the KPI. In one aspect, the set of PM counters is identified using machine learning based statistical method of correlation. Example of the statistical method of correlation comprises at least one of a regression model, random forests model, and a clustering model. Example of the PM counters include, but not limited to, events, success rate, reset events, resource usage, traffic data, and signaling. It is to be noted that the set of PM counters may be preconfigured in the system database 224.

Upon identifying the set of PM counters, the determination module 216 determines a subset of PM counters from the set of PM counters. In order to determine the subset of PM counters, the determination module 216 compares each PM counter with a corresponding predefined threshold limit. In an implementation, a configuration file comprising a list of predefined threshold limit may be stored at the system database 224. In another implementation, the subject matter expert may either override the determination module 216 module to apply a custom threshold or skip the determination module 216 module so that all or a configurable “top-n” influencing PM counters get considered for the normalizing step. It is to be noted that two nodes from the network of nodes may comprise different subsets of PM counters. Thus, in order to compare the two nodes a correlation and variance techniques may be utilized.

Subsequent to determining the subset of PM counters, the normalization module 218 normalizes the subset of PM counters by computing a variance of the subset of PM counters. It is to be noted that by computing variance the subset of PM counters may be compared on a common scale. The term normalization is used to appropriately scale items having different units. In one embodiment, the subset of PM counters may have different units for example milliwatts, decibels, and kilobits/sec. Thus, in order to compare the nodes, the normalization module 218 may scale values corresponding to the subset of PM counters appropriately before applying correlation. Depending upon the kind and nature of values, sometimes normalization may not just apply to scaling the units of samples but also to analyze probabilistic distribution of subset of PM counters.

Once the subset of PM counters is normalized for the node, the profile module 220 may profile one or more nodes present in the network of nodes. In order to profile the one or more nodes, the profile module 220 may compare counter-variances of the node with each node present in the network of nodes. In one example, the one or more nodes having similar variance as that of the node may be profiled by the profile module 220 as identical to the node. Example of profiles may include, but not limited to, a highway cell, a rural cell, a metro cell and an urban cell.

It is important to note that once the one or more nodes are profiled, a patch may be installed at the node to resolve the flag. It is to be noted that the patch may be installed remotely. The patch may be based on the variance corresponding to each of the one or more nodes. In an example, the patch may be a feature activation, rollout/swap-out, fix rollout software code, a hardware equipment, and others.

In an implementation, the profile module 220 may utilize a plotting library to create a radial/polar/spider plot comprising the each of the subset of PM counters mapped against each other. In an example, the radial/polar/spider plot may comprise a list of top-10 counters plotted against each other to be comparable on the common scale.

In order to elucidate further, consider an example of the system 102 in accordance with the embodiment of the present subject matter. The system 102 comprises a network of nodes C1, C2, C3, . . . Cn. Initially, a flag pertaining to an issue at a node C1 is received. Upon receipt of the flag, a HSDPA-Mobility-Failure may be identified as a KPI with the issue at the node C1. It is to be noted that there are approximately 200 PM counters associated to the HSDPA-Mobility-Failure. Thus, in order to resolve the issue, the system may determine top-10 PM counters influencing the KPI by using at least one of a regression model, random forests model, a clustering model, and a correlation model. It is to be noted that a numerical value is associated to each PM counter which represents the extent of correlation of a counter with the KPI. The top-10 PM counters may be determined by comparing the numerical value of each PM counter with a predefined threshold limit. To elucidate more, a table below is shown indicating mean value of each PM counter over a period of two weeks for nodes C1, C2, and C3.

| PM counters | Node C1 | Node C2 | Node C3 |
|---|---|---|---|
| HSDIuRelmobFailure | 576.8889 | 122.4444 | 30.84211 |
| HSDmobHSDToHSD | 541.3333 | 124.4444 | 29.68421 |
| IuRelReqPsPerULRbHSU | 1534.222 | 836.2222 | 459.4737 |
| RABDropPSCellDCHHSU_HSDSCH | 1533.111 | 835.1111 | 457.0526 |
| IuRelReqPsDlHSD | 1622.111 | 1086.889 | 761.1579 |
| IuRelReqPsDlRLCErrTRB | 507.2222 | 410.5556 | 275.2632 |
| RABDropPSCellDCHRelProcIuRelReq | 1568.556 | 1069.222 | 742.9474 |
| IuRelReqPsConn-Ue-Lost | 252.2222 | 196 | 152.1053 |
| RBReconfigFailure | 942.4444 | 542.2222 | 495.1579 |
| IuRelReqPsUlRLCErrSRB | 277.6667 | 73.77778 | 28.94737 |

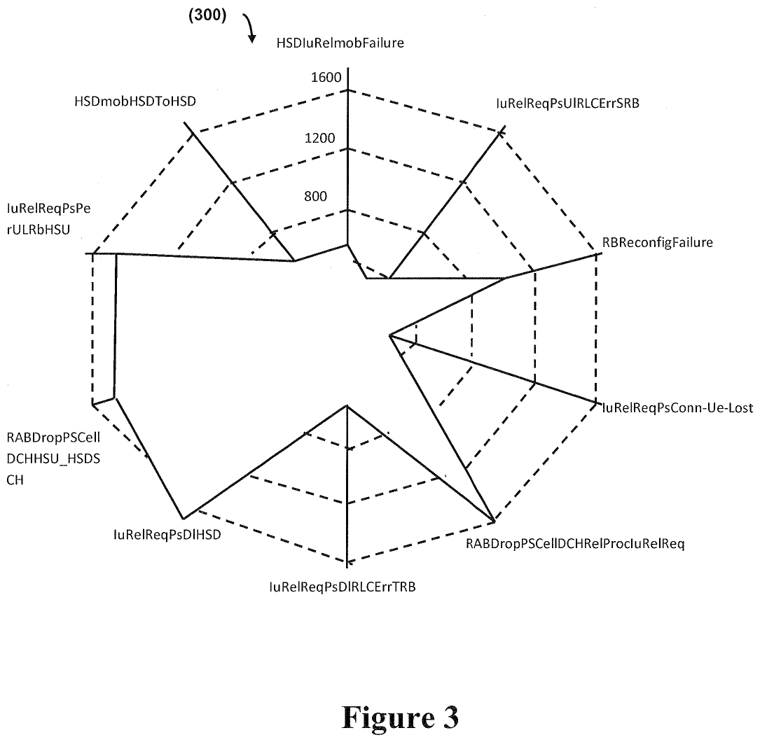

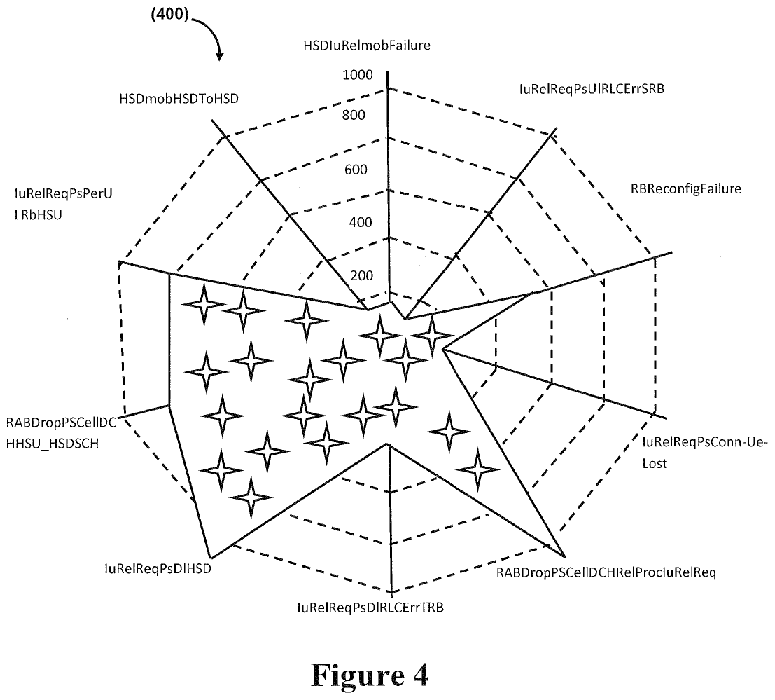

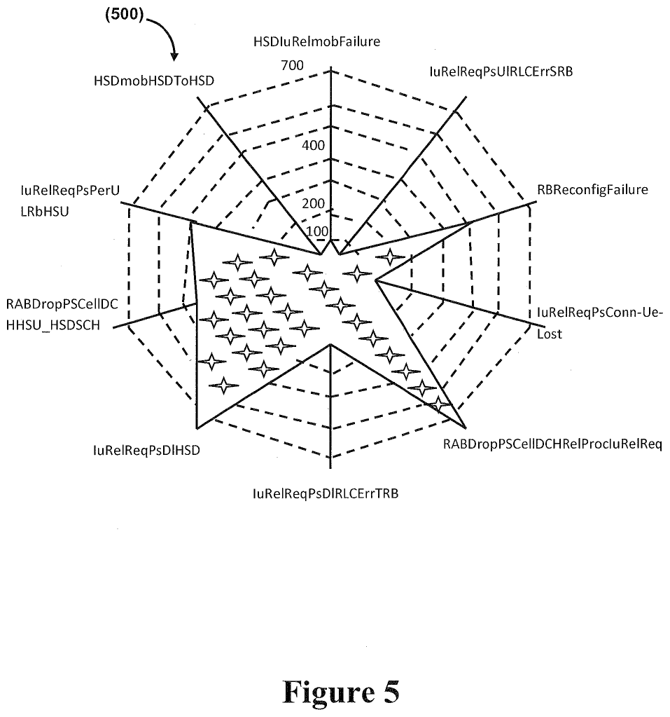

FIGS. 3, 4, and 5 represent radar maps for the nodes C1, C2, and C3 respectively. The FIG. 3 illustrates a radar map 300 having values of top-10 PM counters influencing the HSDPA-Mobility-Failure. FIG. 4 illustrates a radar map 400 having values of top-10 PM counters influencing the HSDPA-Mobility-Failure. FIG. 5 illustrates a radar map 500 having values of top-10 PM counters influencing the HSDPA-Mobility-Failure.

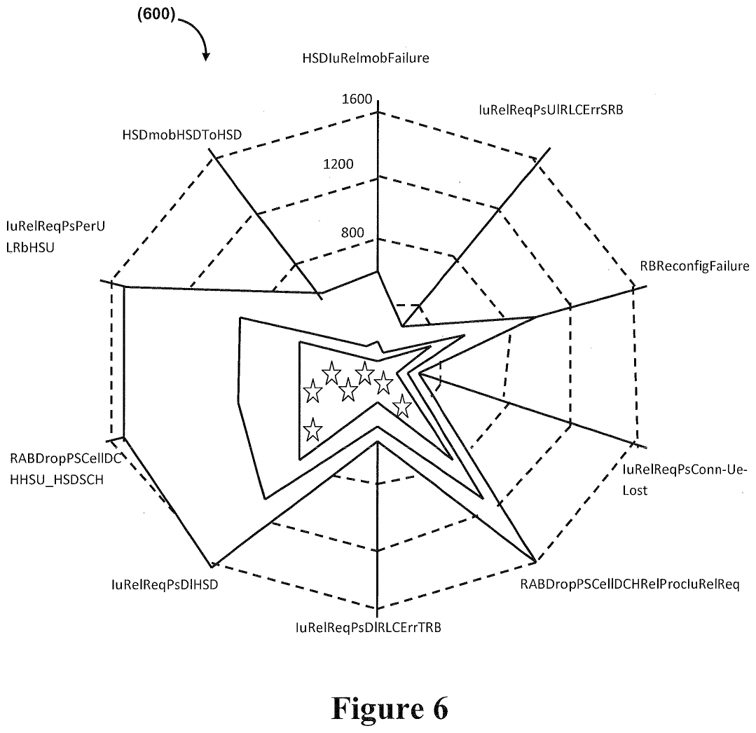

Now referring to FIG. 6, a radar map 600 illustrating a combined view of top-10 PM counters for. C1, C2, and C3 is shown in accordance with the embodiment of the present subject matter. The radar map 600 shows a combined view to present a visual comparison of nodes C1, C2 and C3. Axes represent values of the top-10 PM counters indicating similarity/dis-similarity between the nodes C1, C2, and C3. The radar map 600 facilitates a subject matter expert to analyze and identify the top-10 PM counters influencing the HSDPA-Mobility-Failure. The subject matter expert may install a patch for resolving the issue with the HSDPA-Mobility-Failure at the nodes C1, C2, and C3. Upon installing, the subject matter expert may confirm that a fix that resolved a problem for C1 may also be applicable to C2 and C3. In an embodiment, the subject matter expert may install a patch to improve functioning of the nodes C1, C2, and C3.

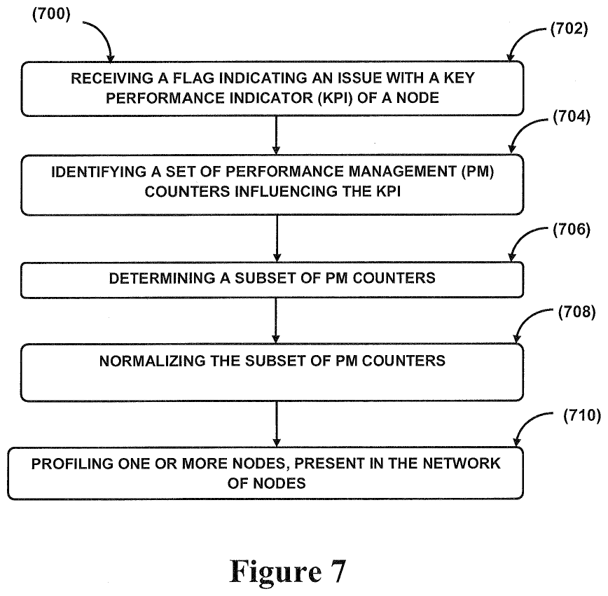

Referring now to FIG. 7, a method 700 for profiling one or more nodes based on a Key Performance Indicator (KPI) associated to a node in a communication network is shown, in accordance with an embodiment of the present subject matter. The method 700 may be described in the general context of computer executable instructions. Generally, computer executable instructions can include routines, programs, objects, components, data structures, procedures, modules, functions, etc., that perform particular functions or implement particular abstract data types. The method 700 may also be practiced in a distributed computing environment where functions are performed by remote processing devices that are linked through a communications network. In a distributed computing environment, computer executable instructions may be located in both local and remote computer storage media, including memory storage devices.

The order in which the method 700 is described is not intended to be construed as a limitation, and any number of the described method blocks can be combined in any order to implement the method 700 or alternate methods. Additionally, individual blocks may be deleted from the method 700 without departing from the spirit and scope of the subject matter described herein. Furthermore, the method can be implemented in any suitable hardware, software, firmware, or combination thereof. However, for ease of explanation, in the embodiments described below, the method 700 may be considered to be implemented as described in the system 102.

At block 702, a flag indicating an issue with a Key Performance Indicator (KPI) of a node present in a network of nodes may be received. In one implementation, the flag may be received by a receiving module 212.

At block 704, a set of Performance Management (PM) counters influencing the KPI may be identified. In one aspect, the set of PM counters is identified using machine learning based statistical method of correlation. In one implementation, the set of PM counters may be identified by an identification module 214.

At block 706, a subset of PM counters may be determined from the set of PM counters. In one aspect, the subset of PM counters may be identified by comparing each PM counter with a corresponding predefined threshold limit. In one implementation, the subset of PM counters may be determined by a determination module 216.

At block 708, the subset of PM counters may be normalized by computing a variance of the subset of PM counters. In one implementation, the subset of PM counters may be normalized by a normalization module 218.

At block 710, one or more nodes, present in the network of nodes, may be profiled by comparing the variance associated to the node with variance corresponding to each of the one or more nodes. In one implementation, the one or more nodes may be profiled by a profile module 220.

Exemplary embodiments discussed above may provide certain advantages. Though not required to practice aspects of the disclosure, these advantages may include those provided by the following features.

Some embodiments enable profiling of one or more nodes in real time based on the KPI.

Some embodiments enable a system and a method to analyze each node present in the network of nodes using analytical graphs.

Some embodiments enable a system and a method to compare one or more nodes based on the KPI including, but not limited to, call success rate, throughput, and handover rate.

Some embodiments enable a system and a method to instantaneously locate and fix issues related to one or more nodes.

Some embodiments enable a system and a method to automate patch installation at one or more nodes.

Some embodiments enable a system and a method to replicate network procedures at the one or more nodes simultaneously.

Some embodiments enable a system and a method to reduce costs incurred to identify and resolve the issue at the node.

Some embodiments enable a system and a method to expedite network level operations and facilitate subject matter experts with profiling mechanism to audit nodes and choose fix applicability.

Although implementations for methods and systems for profiling one or more nodes based on a Key Performance Indicator (KPI) associated to a node in a communication network have been described in language specific to structural features and/or methods, it is to be understood that the appended claims are not necessarily limited to the specific features or methods described. Rather, the specific features and methods are disclosed as examples of implementations for profiling one or more nodes based on a Key Performance Indicator (KPI) associated to a node in a communication network.

We claim:

1. A system for profiling one or more nodes based on a Key Performance Indicator (KPI) associated to a node in a communication network, the system comprising:
a memory;
a processor coupled to the memory, wherein the processor is configured to execute programmed instructions stored in the memory for:
receiving a flag indicating an issue with a Key Performance Indicator (KPI) of a node present in a network of nodes;
identifying a set of Performance Management (PM) counters influencing the KPI, wherein the set of PM counters is identified using machine learning based statistical method of correlation;
determining a subset of PM counters, from the set of PM counters, by comparing each PM counter with a corresponding predefined threshold limit;
normalizing the subset of PM counters by computing a variance of the subset of PM counters; and
profiling one or more nodes, present in the network of nodes, by comparing the variance associated to the node with a variance corresponding to each of the one or more nodes.

2. The system of claim 1 further comprises installing a patch at the node to resolve the flag, wherein the patch is installed based on the variance in the subset of PM counters.

3. The system of claim 1, wherein the variance corresponding to each of the one or more nodes is similar to the variance associated to the node.

4. The system of claim 1, wherein the statistical method of correlation comprises at least one of a regression model, random forests model, and a clustering model.

5. The system of claim 1, wherein the PM counters comprise at least one of events, success rate, reset events, resource usage, traffic data, and signaling.

6. The system of claim 1, wherein the KPI comprises at least one of call drop rate, network failure, equipment failure, response time, waiting time, probability of immediate execution, CPU utilization, and throughput.

7. A method for profiling one or more nodes based on a Key Performance Indicator (KPI) associated to a node in a communication network, the method comprising:
receiving, by a processor, a flag indicating an issue with a Key Performance Indicator (KPI) of a node present in a network of nodes;
identifying, by the processor, a set of Performance Management (PM) counters influencing the KPI, wherein the set of PM counters is identified using machine learning based statistical method of correlation;
determining, by the processor, a subset of PM counters, from the set of PM counters, by comparing each PM counter with a corresponding predefined threshold limit;
normalizing, by the processor, the subset of PM counters by computing a variance of the subset of PM counters; and
profiling, by the processor, one or more nodes, present in the network of nodes, by comparing the variance associated to the node with a variance corresponding to each of the one or more nodes.

8. The method of claim 7 further comprises installing a patch at the node to resolve the flag, wherein the patch is installed based on the variance in the subset of PM counters.

9. The method of claim 7, wherein the variance corresponding to each of the one or more nodes is similar to the variance associated to the node.

10. The method of claim 7, wherein the statistical method of correlation comprises at least one of a regression model, random forests model, and a clustering model.

11. The method of claim 7, wherein the PM counters comprise at least one of events, success rate, reset events, resource usage, traffic data, and signaling.

12. The method of claim 7, wherein the KPI comprises at least one of call drop rate, network failure, equipment failure, response time, waiting time, probability of immediate execution, CPU utilization, and throughput.

13. A computer program product having embodied thereon a computer program for profiling one or more nodes based on a Key Performance Indicator (KPI) associated to a node in a communication network, the computer program product comprising:
a program code for receiving a flag indicating an issue with a Key Performance Indicator (KPI) of a node present in a network of nodes;
a program code for identifying a set of Performance Management (PM) counters influencing the KPI, wherein the set of PM counters is identified using machine learning based statistical method of correlation;
a program code for determining a subset of PM counters, from the set of PM counters, by comparing each PM counter with a corresponding predefined threshold limit;
a program code for normalizing the subset of PM counters by computing a variance of the subset of PM counters; and
a program code for profiling one or more nodes, present in the network of nodes, by comparing the variance associated to the node with a variance corresponding to each of the one or more nodes.
